(19) United States
(12) Patent Application Publication
(10) Pub. No.: US 2013/0046637 A1
(43) Pub. Date: Feb. 21, 2013

(54) SYSTEM AND METHOD FOR INTERACTIVE PROMOTION OF PRODUCTS AND SERVICES

(71) Applicants: Bradley A. SLUTSKY, Atlanta, GA (US); Frank T. YOUNG, Atlanta, GA (US)

(72) Inventors: Bradley A. SLUTSKY, Atlanta, GA (US); Frank T. YOUNG, Atlanta, GA (US)

(73) Assignee: Firethorn Mobile, Inc., Atlanta, GA (US)

(21) Appl. No.: 13/248,937

(22) Filed: Sep. 29, 2011

Related U.S. Application Data
(60) Provisional application No. 61/525,649, filed on Aug. 19, 2011.

(51) Int. Cl. G06Q 30/02

(52) U.S. Cl. 705/14.66

(57) ABSTRACT

A method and system for interactively promoting the sale of a product or service are described. The method and system includes capturing an image of a consumer with a video camera. Next, a biometric scan of the image may be conducted to determine if at least one biometric has been recognized from the scan. The biometric scan usually comprises a facial recognition scan. If one biometric has been recognized from the scan, the system may access a database comprising biometrics associated with at least one of browsing history, purchase history, and preference data associated with a consumer. The system may then display advertising images on a display device comprising a product or service augmented with one or more images of the consumer and which correspond with data stored in the database. The system may convey options for initiating a sale and preserving the sale of the product or service.

### PRIORITY AND RELATED APPLICATIONS STATEMENT

This patent application claims priority under 35 U.S.C. §119(e) to U.S. Provisional Patent application Ser. No. 61/525,649, filed on Aug. 19, 2011, entitled, “SYSTEM AND METHOD FOR INTERACTIVE PROMOTION OF PRODUCTS AND SERVICES,” the entire contents of which are hereby incorporated by reference.

### DESCRIPTION OF THE RELATED ART

Product manufacturers, merchants, and service vendors spend billions of dollars every year to advertise their products and services to the public. One major problem with advertising is it is difficult to catch or draw the attention of an individual consumer as well as groups of consumers who may span a broad range of demographics.

Billboards, magazine advertisements, newspaper advertisements, online interactive advertisements and the like typically project images of human models that are usually pleasing to the eye. Often, human models are dressed and styled to look like an average or ordinary consumer. In other instances, the human models may include celebrities and professional athletes. These celebrities and professional athletes are usually of interest to the general public and to potential consumers of the products and services being advertised.

Problems with using human models include high wages for employing these models as well as the risk that some human models may not attract or draw the attention of broad ranges of the population (the demographics) targeted for the products and services being advertised. Other problems include the lag time between photo shoots or videos before the photographs or videos may be placed into commerce for advertising the products and services offered.

Another problem with traditional advertising methods is that it has a single function for only advertising the products and services being offered. An advertisement is usually a single function display that may be dismissed or skipped by the ordinary consumer.

Accordingly, what is needed is a system and method that may overcome the problems associated with traditional advertising methods. Specifically, what is needed in the art is a system and method for interactive promotion of products and services that engages the ordinary consumer and provides targeted advertising based on specific, personal consumer preferences.

### SUMMARY OF THE DISCLOSURE

A method and system for interactively promoting the sale of a product or service are described. The method and system include capturing an image of a consumer with a video camera. Next, a biometric scan of the image may be conducted to determine if a biometric has been recognized from the scan. The biometric scan usually comprises a facial recognition scan. If a biometric has been recognized from the scan, the system may access a database comprising biometrics associated with at least one of browsing history, purchase history, and preference data associated with a consumer. The system may then display advertising images on a display device comprising a product or service augmented with one or more images of the consumer and which correspond with data stored in the database. The system may convey options for initiating a sale and preserving a sale of the product or service. The options may be conveyed with video and/or audio messages.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral encompass all parts having the same reference numeral in all Figures.

FIG. 1 is a diagram of a display for an interactive advertising system that may augment a scene with the images of a consumer;

FIG. 2 is a diagram of the main elements of a system for interactive promotion of products and services that engages the ordinary consumer and provides targeted advertising based on a specific consumer's preferences;

FIG. 3 is a diagram of the multiple interactive advertising systems coupled together across a communications network;

FIG. 4 is a diagram of main components for an exemplary central controller illustrated in FIG. 2;

FIG. 5 is a table listing a plurality of rules that may be part of the rules engine illustrated in FIG. 2;

FIG. 6 is a diagram of an interactive advertising system that has augmented computer-generated scenes to include images of consumers;

FIG. 7 is a diagram of an interactive advertising system that is part of a vending machine, storefront, or billboard;

FIG. 8 is a diagram of an interactive advertising system that has augmented a plurality of computer-generated scenes to include an image of a single consumer;

FIG. 9 is a diagram of an interactive advertising system that displays products or services or both that are based on preferences of a consumer that are stored in a database;

FIG. 10 is a diagram of an interactive advertising system that displays a plurality of options for completing a purchase transaction or for preserving a potential purchase transaction;

FIG. 11 is a diagram of an interactive advertising system that displays options for completing a purchase transaction;

FIG. 12 is a diagram of an interactive advertising system that displays instructions on how to complete a purchase transaction using the interactive advertising system;

FIG. 13 is a diagram illustrating an interactive advertising system that displays a purchase confirmation screen and options for changing the products and services currently being advertised on the interactive advertising system;

FIG. 14 is a diagram illustrating an interactive advertising system that displays a new set of product categories that are specific to a consumer based on preferences and prior purchase data available to the interactive advertising system; and

FIGS. 15A-15B are flowcharts illustrating a method for managing transactions with a PCD.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone,” “wireless communication device,” and “wireless handset” are used interchangeably. With the advent of third generation (“3G”) wireless technology and four generation (“4G”), greater bandwidth availability has enabled more portable computing devices with a greater variety of wireless capabilities. Therefore, a portable computing device may include a cellular telephone, a pager, a PDA, a smartphone, a navigation device, or a hand-held computer with a wireless connection or link.

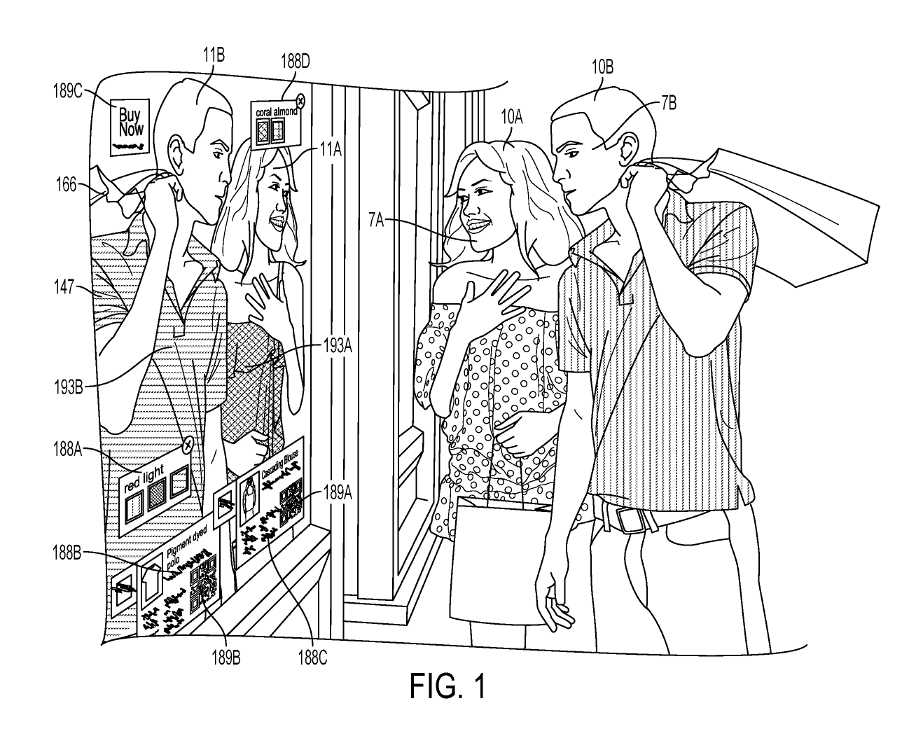

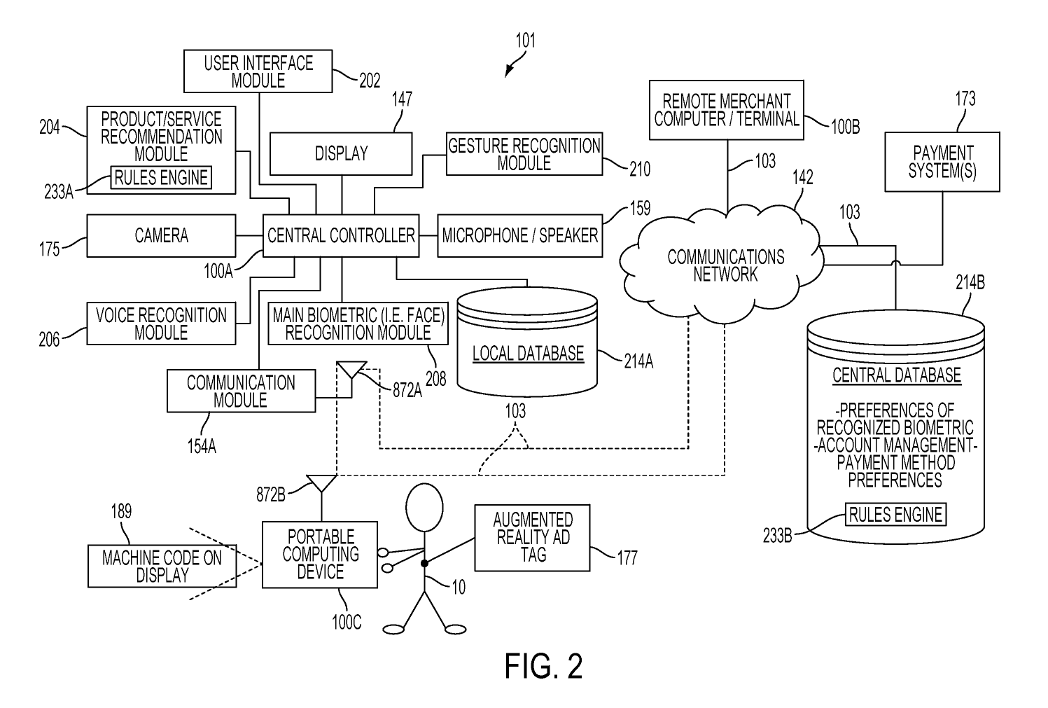

Referring initially to FIG. 1, this figure is a diagram of a display 147 for an interactive advertising system 101 (See FIG. 2 for core elements of system 101) that may augment a virtual scene 166 projected on the display 147 with the images 11A, 11B of a consumer 10A, 10B. As illustrated in this figure, two consumers 10A, 10B may be walking down a street. The consumers 10A, 10B may notice how a store front display 147 has generated a virtual scene 166 that comprises moving video images 11A, 11B that look exactly like the consumers 10A, 10B with certain elements modified.

These moving video images 11A, 11B will likely catch the attention of the consumers 10A, 10B since the images 11A, 11B look almost exactly like the consumers 10A, 10B. However, some differences may exist between the images 11A, 11B and the consumers 10A, 10B. One difference is that the images 11A, 11B may be augmented such that the images 11A, 11B of the consumers may be interacting with products and/or services. The images 11A, 11B may comprise moving video so that the images 11A, 11B track the movement of the consumers 10A, 10B.

In the exemplary embodiment illustrated in FIG. 1, the images 11A, 11B have been further augmented to include clothing products 193. Specifically, each image 11A, 11B has been augmented or changed so that it appears that each image 11A, 11B of the consumer 10A, 10B is wearing the clothing 193 being advertised with the interactive advertising system 101.

In the example illustrated in FIG. 1, the female consumer 10A is shown her image 11A wearing a blouse 193A that is being offered for sale. Similarly, the male consumer 10B is shown his image 11B wearing a shirt 193B that is being offered for sale. In addition to displaying the images 11A, 11B of the consumers 10A, 10B, the display 147 may also project a user interface that may comprise various menus 188 of options for changing the products 193 and/or changing the virtual scene 166 comprising the images 11A, 11B of the consumers 10A, 10B. In the specific, yet exemplary embodiment of FIG. 1, the menus 188 may comprise options for changing the colors, sizes, textures, and styles of clothing 193 that are being offered for sale by the interactive advertising system 101. As understood by one of ordinary skill in the art, the system 101 is not limited to products 193 of clothing. Other products and services may include, but are not limited to, fashion accessories, food, household goods, vehicles, vacations, and any services offered in an industry (i.e. legal services, accounting services, Internet, telephone, mobile phone, etc.).

In addition to displaying menus 188 of options for changing the products and/or services being offered, the display 147 may also project multiple options 189 for purchasing the products and/or services being offered. In the exemplary embodiment illustrated in FIG. 1, the options 189 for purchasing the products and/or services being offered may comprise machine-readable codes 189A, 189B such as two-dimensional (“2-D”) barcodes that may be scanned with a portable computing device 100C, like a mobile phone.

The 2-D barcode may include, but is not limited to, the following symbologies: Aztec Code, 3-DI, ArrayTag, Small Aztec Code, Chromatic Alphabet, Chromocode, Codablock, Code 1, Code 16K, Code 49, ColorCode, Compact Matrix Code, CP Code, CyberCode, d-touch, DataGlyphs, Datamatrix, Datastrip Code, Dot Code A, EZcode, Grid Matrix Code, High Capacity Color Bar code, HueCode, INTACTA.CODE, InterCode, MaxiCode, mCode, MiniCode, Micro PDF417, MMCC, Nintendo e-Reader#Dot code, Optar, PaperDisk, PDF417, PDMark, QR Code, QuickMark Code, Semacode, SmartCode, Snowflake Code, ShotCode, SuperCode, Trillcode, UltraCode, UnisCode, VeriCode, VSCode, WaterCode, for example.

Instead of a two dimensional bar code, a one dimensional bar code may be employed. Exemplary one-dimensional bar codes may include, but are not limited to, U.P.C., Codabar, Code 25 —Non-interleaved 2 of 5, Code 25 —Interleaved 2 of 5, Code 39, Code 93, Code 128, Code 128A, Code 128B, Code 128C, Code 11, CPC Binary, DUN 14, EAN 2, EAN 5, EAN 8, EAN 13, Facing Identification Mark, GS1-128 (formerly known as UCC/EAN-128), GS1 DataBar formerly Reduced Space Symbology (“RSS”), HIBC (HIBCC Bar Code Standard), ITF-14, Latent image bar code, Pharmacode, Plessey, PLANET, POSTNET, Intelligent Mail Bar code, MSI, PostBar, RM4SCC/KIX, JAN, and Telepen.

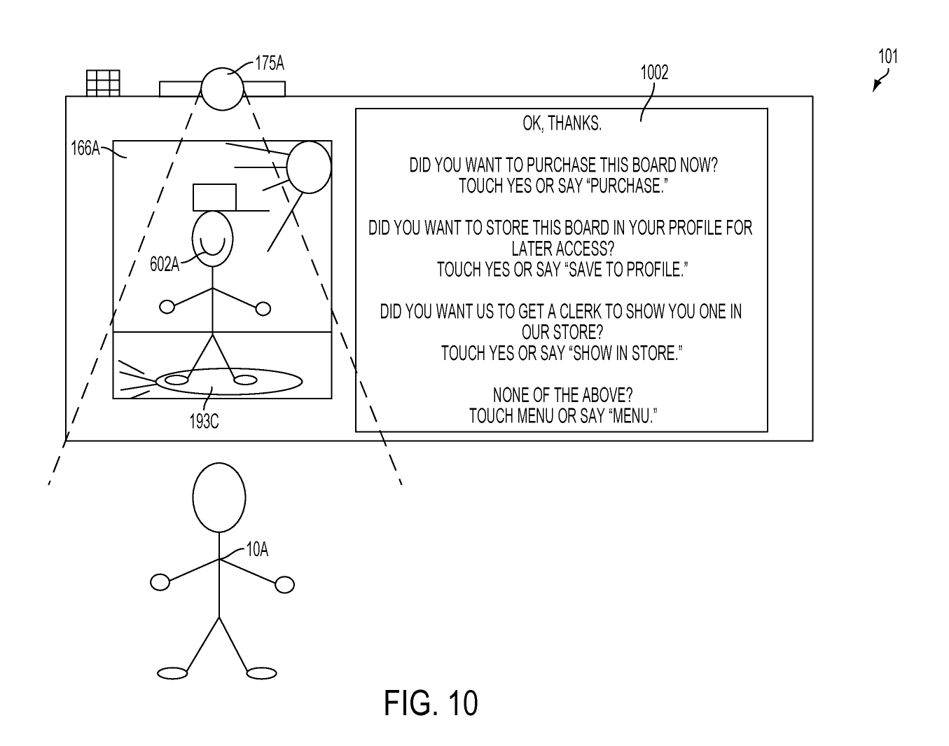

Other machine readable codes are well within the scope of the disclosure such as contact-less or wireless communication methods such as near-field communications (“NFCs”) used with smart cards and radio-frequency identification (“RF-ID”) cards as understood by one of ordinary skill in the art. The options 189 may comprise a “buy now” button 189C that transforms the display 147 into an online shopping cart, such as illustrated in FIGS. 10-12 and as will be described below.

Fundamentally, the interactive advertising system 101 will allow the consumer 10 to change almost anything that is being projected on the display 147. This means that the consumer 10 may turn the display 147 of the system 101 into the consumer's personal catalog for products/services 193 in which the image 11 of the consumer 10 is the model for each product and/or service 193 being projected onto the display 147. The system 101 may show an exact image 11 of the consumer 10 or it may augment physical features of the images 11 of the consumer 10, such as adding a facial expression like a smile to the image 11.

Alternatively, the system 101 may increase or decrease one or more of the weight, height, and age of the image 11 in response to any direction provided by the consumer 10. The system may also allow the consumer 10 to adjust any features of the products and/or services. For example, the consumer 10 may adjust the sizes of products being offered, such as adjusting the size of clothing to “see” how the clothing would fit on the image 11 of the consumer 10 when different sizes are selected.

The system 101 may allow the consumer 10 to specify that one or more additional screens should be shown on the display 147 with the same or different products/services for comparison. The system 101 may allow the consumer 10 to create an account where they can input one or more of their product and service preferences, preferences associated with the display 147, shipping information, and payment information. The system 101 may provide the ability to save what is shown on the display 147 to the consumer's account held in the central database 214B (where the data may be retrieve for later viewing).

Additionally, the system may add computer generated images of celebrities and/or models which interact with the images 11 of the consumer 10 so that the consumer 10 can see his or herself in a virtual world interacting with other virtual, but “real-looking” people. The consumer 10 may select the additional virtual people and/or the system 101 may select the additional virtual people relative to the image 11 of the consumer 10. The consumer 10 may also suggest the virtual scene 166 in which his image 11 is projected such as a beach scene, a ski slope scene, a swimming scene, etc.

In addition to providing a catalog of products and services available to the consumer 10, the interactive advertising system 101 may also suggest products and/or services that may be desired by the consumer 10. The suggestions made by the interactive advertising system 101 may be based on a consumer's prior interaction with the interactive advertising system 101 and/or based upon preferences that are stored in a remote database 214 (See FIG. 2). The system 101 may upsell the consumer 10 on more expensive products and/or services when he or she is making a purchase.

Purchases may be made by the consumer 10 in which the consumer 10 scans a QR code with a phone, or by using WIFI/Bluetooth connections to a phone, or using near-field communication (“NFC”) equipped phones, or using the display 147 like a personal computer (“PC”) to make an on-line purchase. After the purchase is made, electronic receipts may be sent to the consumer 10 by e-mail, to the consumer's phone, and/or stored in an account in the central database 214.

One unique aspect of the system 101 is that the consumer 10 may be permitted to select virtual catalogs from a first merchant while the display 147 of the system 101 may be physically located on the premises of a second merchant.

Another unique feature of the system 101 is that it may employ facial recognition techniques to recognize the faces 7 of consumers 10. The system 101 may then create user profiles that are associated with faces 7 of the consumer 10 so that personalized and specific offers may be made to each consumer 10 based on his or her individual profile tracked by system 101. The system 101 is not limited to facial recognition techniques and may employ any other type of biometric recognition technique as understood by one of ordinary skill the art. For example, the system 101 may employ fingerprint recognition techniques as well as voice recognition techniques to create a profile relative to a consumer 10. Other biometric recognition techniques include, but are not limited to, hand shape recognition, retina scans, DNA scans, and the like.

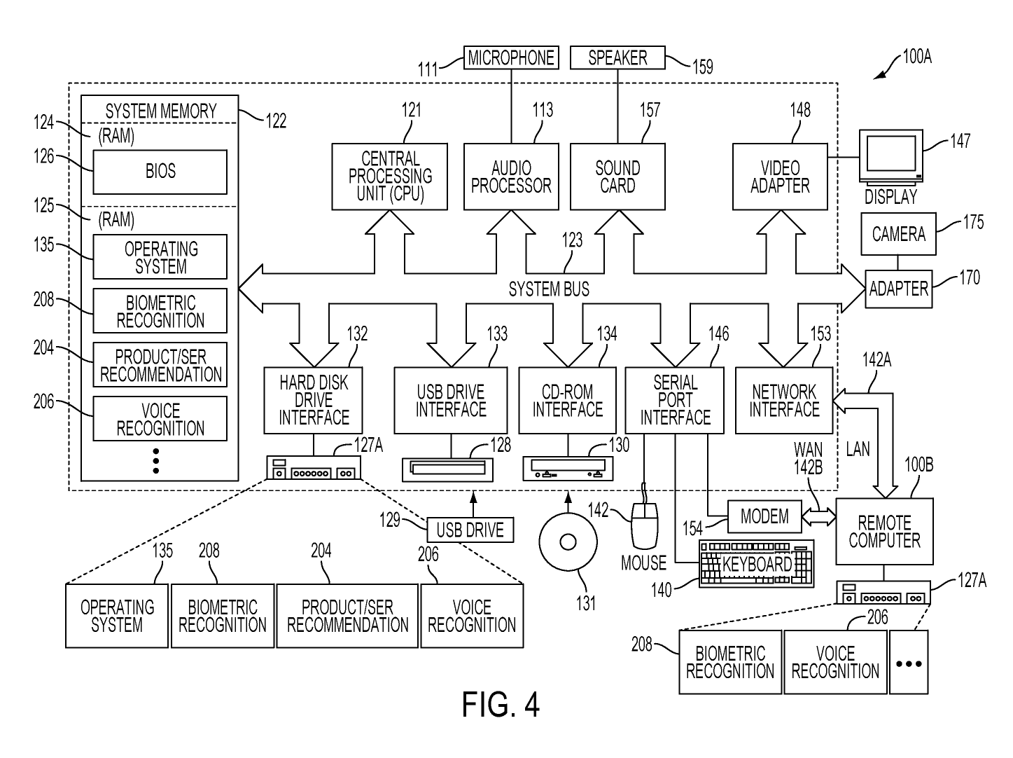

FIG. 2 is a diagram of the main elements of a system 101 for interactive promotion of products and services (an interactive advertising system 101) that engages the ordinary consumer 10 and provides targeted advertising based on a specific consumer's preferences. The interactive advertising system 101 may comprise a central controller 100A. The central controller 100A may comprise a central processing unit 121 as well as other components of a general purpose computer as will be described below in connection with FIG. 4.

The central controller 100A may be coupled to several other components, such as, but not limited to, the following: a user interface module 202, a product/service recommendation module 204 that may include a rules engine 233, a camera 175, a voice-recognition module 206, a communication device 154A, a main biometric recognition module 208, a local database 214A, a microphone and/or speaker 159, a gesture recognition module 210, and a display 147.

The user interface module 202 may comprise software and/or hardware that is responsible for controlling and displaying the menus 188 that are projected on the display 147. As will be described below, the menus 188 are not limited to visual ones and may include audible ones in which voice-recognition may be used by the system 101. Other forms of menus are included, such as gesture driven ones in which the hand or arm movements of a consumer 10 are tracked by the system 101, and more particularly the gesture recognition module 210 as described below. The user interface module 202 is responsible for receiving the input provided by the consumer 10 who is interacting with the system 101.

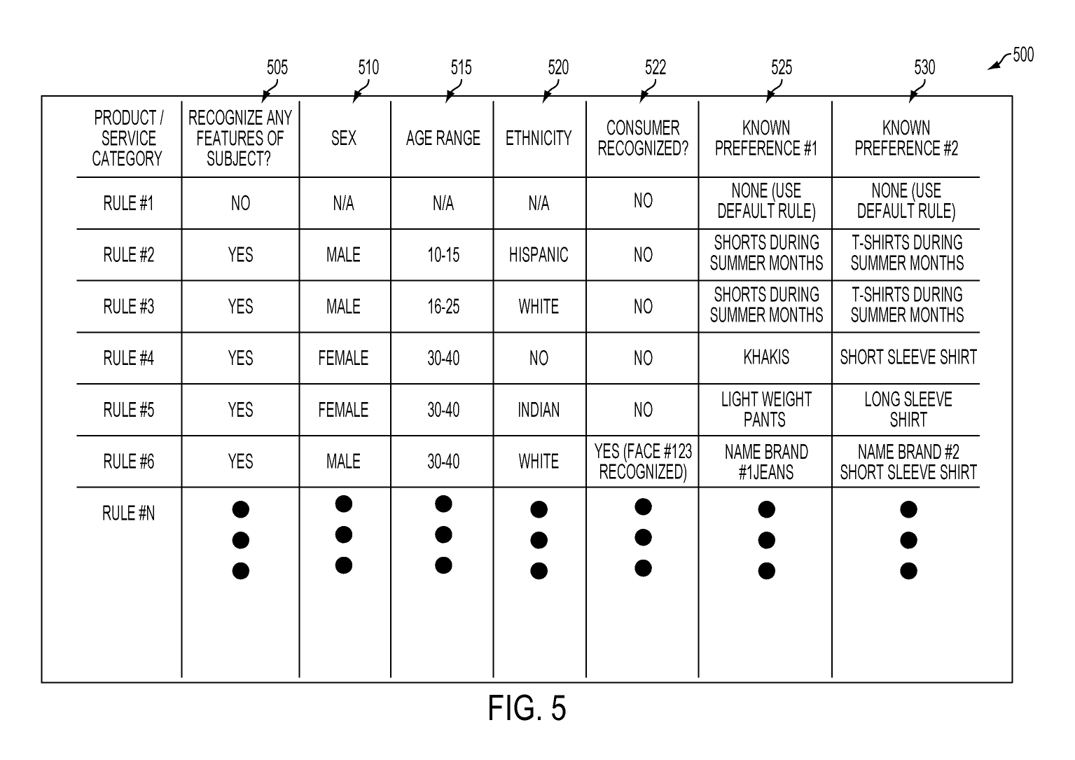

The product/service recommendation module 204 may comprise software and/or hardware. This module 204 may be responsible for recommending various products and/or services that will likely be preferred by the consumer 10 based on any profiles and/or history of interaction associated with a consumer 10 that may be recognized by the system 101. One exemplary product/service recommendation module 204 that exists as of this writing is one manufactured by Xiam, a subsidiary of Qualcomm Incorporated. The module 204 may comprise a rules engine 233A that is associated with demographic data that is tracked by the system 101. The rules engine 233A may comprise rules that will be described in further detail below in connection with FIG. 5.

The camera 175 may comprise a video camera. The camera 175 may include a CCD (charge-coupled device) camera or a CMOS (complementary metal-oxide-semiconductor) camera. The camera will preferably capture at least 30 frames per second or faster. One exemplary camera 175 sold as of this writing is KINECT™, manufactured by MICROSOFT™. The camera 175 may also comprise internal software and/or hardware or it may be connected to external software and/or hardware that may recognize human body parts when images of consumers 10 are within a field of view for the camera 175. The voice-recognition module 175 may comprise software and/or hardware. This module 175 may be used to recognize audible commands issued by a consumer 10 who interacts with the display 147 of the system 101.

The communication device 154A may comprise a device that links the system 101 with a portable computing device 100C that may be operated by the consumer 10. The communication device 154A may also comprise a device that links the system 101 with a communications network 142. In this exemplary scenario, the communication device 154 may comprise a modem or radio-frequency (“RF”) wireless card as understood by one of ordinary skill in the art.

The portable computing device (“PCD”) 100C and communication device 154A of the system 101 are coupled to a communications network 142 via communication links 103. Many of the system elements illustrated in FIG. 2 are coupled via communications links 103 to the communications network 142.

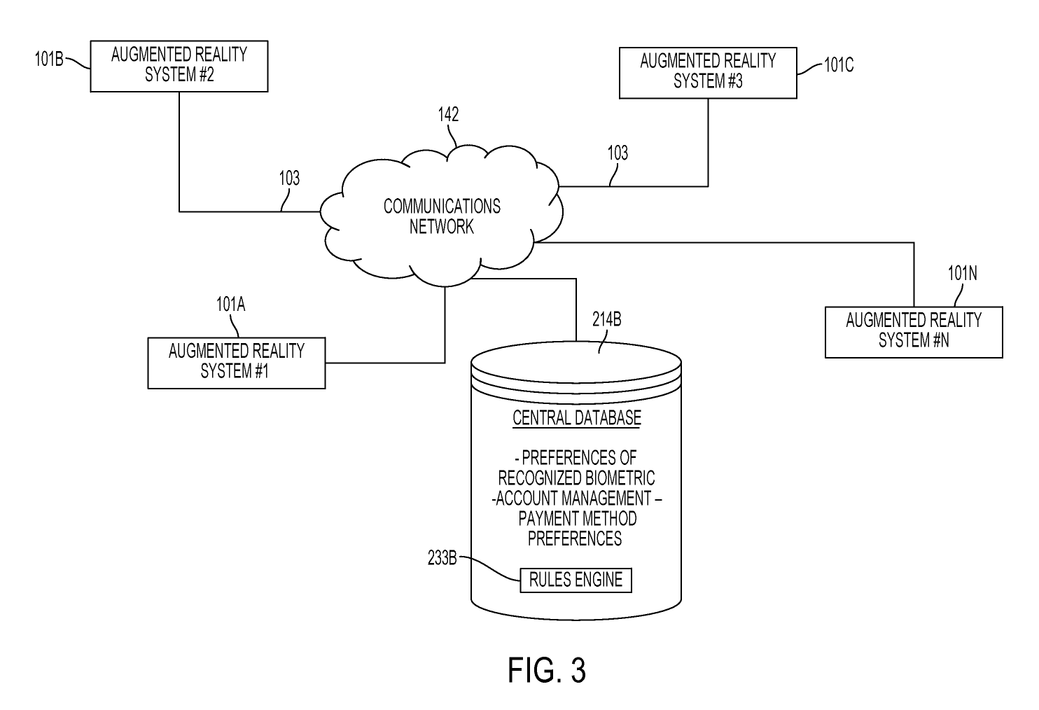

The links 103 illustrated in FIG. 3 may comprise wired or wireless couplings or links. Wireless links include, but are not limited to, radio-frequency (“RF”) links, infrared links, acoustic links, and other wireless mediums. The communications network 142 may comprise a wide area network (“WAN”), a local area network (“LAN”), the Internet, a Public Switched Telephony Network (“PSTN”), a paging network, or a combination thereof. The communications network 142 may be established by broadcast RF transceiver towers (not illustrated). However, one of ordinary skill in the art recognizes that other types of communication devices besides broadcast RF transceiver towers are included within the scope of this disclosure for establishing the communications network 142.

The PCD 100C and communication device 154A of the system 101 are shown to have an antenna 872 so that each element may establish wireless communication links 103 with the communications network 142 via RF transceiver towers (not illustrated). Alternatively, the communication device 154A of the system 101 may be directly coupled to the communications network 142 with a wired connection. The system 101 may communicate directly with the PCD 100C with the system 101 or it may communicate indirectly with the PCD 100C using the communication network 142.

The main biometric recognition module 208 may recognize one or more features or characteristics of the human body. According to one exemplary embodiment, the main biometric recognition module 208 may recognize facial features of humans as understood by one of ordinary skill the art. In addition to recognizing facial features of humans, the main biometric recognition module 208 may recognize fingerprints, hand shapes, and other similar features of humans as understood by one of ordinary skill in the art. In this way, the biometric module 208 may uniquely identify each consumer 10 by his or her distinct face.

The biometric module 208 may record and log its entries of biometric features of consumers 10 into a local database 214A. This local database 214A may comprise a structured query language (“SQL”) database as understood by one of ordinary skill in the art. According to one interesting aspect of the system 101, the system 101 may create profiles of individual consumers 10 based upon their facial features. In this way, a profile may be created for the consumer 10 without ever requiring the consumer 10 provide a secondary, unique identifier such as a name for the consumer 10. The local database 214A may also maintain preferences that have been associated with the profiles created for each uniquely identified face of the consumer 10. The local database 214A at some point in time may associate each stored face with a corresponding name if a consumer 10 desires to associate his or her face with his or her name. The local database 214A may also maintain and track payment method preferences associated with the unique face profile. The local database 214A may store payment information such as credit card numbers, bank account numbers, and alternative payment accounts (i.e. Paypal, BillMe Later, Google payments, etc.).

The microphone and/or speaker 159 may comprise conventional hardware and/or software components as understood by one of ordinary skill the art. The gesture recognition module 210 may comprise hardware and/or software that may associate a list of commands with hand gestures as understood by one of ordinary skill the art.

The display 147 may comprise any type of display devices such as a liquid crystal display (LCD), a plasma display, an organic light-emitting diode (OLED) display, and a cathode ray tube (CRT) display. One exemplary display 147 suitable for the system 101 known as of this writing is one manufactured by Mirasol, a subsidiary of Qualcomm Incorporated.

As illustrated in FIG. 2, the system 101 may communicate directly with the portable computing device 100C that is carried by the consumer 10. The portable computing device may include a cellular telephone, a pager, a Portable Digital Assistant (“PDA”), a tablet personal computer (“PC”), a smartphone, a navigation device, or a hand-held computer with a wireless connection or link.

The portable computing device 100C may scan the machine-readable code 189 projected on the display 147. An exemplary embodiment of the machine-readable code 189 is illustrated in FIG. 1 as described above. This machine-readable code 189 may allow the portable computing device 100C to relay appropriate product and/or service information to a remote merchant computer/terminal 100B that is coupled to the communications network 142.

The interactive advertising system 101 may communicate with a central database 214B via the communications network 142. The central database 214B may store data similar to the data stored by each local database 214A. However, the central database 214B may track and store data that is collected from a plurality of interactive advertising systems 101. Additionally, the central database 214B may also track data associated with online purchases as well as in-store purchases made by a particular consumer. The central database 214B may also comprise a rules engine 233B that is similar to the rules engine 233A of the system 101. In this way, the central database 214B may provide each interactive advertising system 101 with product and or service recommendations based on preference data that is maintained by the central database 214B.

The remote merchant computer/terminal 100B may comprise a general-purpose computer similar to the one which will be described in connection with FIG. 4 discussed below. The remote merchant computer/terminal 100B may receive requests from either the system 101 or the portable computing device 100C. The request may include directions for a merchant to pull a product 193 from a shelf and to earmark the product for a particular consumer 10 who desires to see the product 193 prior to purchase. Alternatively, the request may be a purchase order request in which the consumer 10 has completed a purchase transaction and is ready to pick up the product or service 193.

The interactive advertising system 101 may also be coupled to a payment system module 173. The payment system module 173 may comprise traditional payment systems/networks as well as alternative payment systems/networks. Traditional payment systems/networks include, but are not limited to, exemplary networks such as the VISA™ credit card network, the MASTERCARD™ credit card network, the DISCOVER™ credit card network, the AMERICAN EXPRESS™ credit card network, and other similar charge or debit card proprietary networks.

Meanwhile, the alternate payment systems/networks of the payment systems module 173 may be responsible for handling and managing non-traditional or alternative payment processing. For example, alternative payment processing may include, but is not limited to, processing payments from accounts associated with certain online financial institutions or other service providers, like PAYPAL™, BILL ME LATER™, Wii™, APPLE™, GREEN DOT™, and mobile phone carriers like SPRINT™ and VERIZON™.

The interactive advertising system 101 may further comprise a tag 177 or some other indicator that communicates preferences to the central controller 100A. A consumer 10 may wear the tag 177 to signify that he or she does not want to participate or be tracked by each interactive advertising system 101. The tag 177 may also be mounted on an item carried by the consumer 10 such as on the portable computing device 100B. In this way, when the interactive advertising system 101 detects the tag 177, it may exclude the consumer 10 wearing this tag 177 from any advertising being displayed with the system 101. The tag 177 may be provided with a plurality of programmable options so that a consumer 10 may be selective with respect to the types of advertising he or she may be interested in and would be willing to participate in relative to the interactive advertising system 101. The tag 177 may comprise a visual indicator and/or a radio-frequency/NFC identifier that can be easily detected by the central controller 100A. In some exemplary embodiments, the tag 177 may be used primarily for consumers who aren't in the central database 214 of the system 100 and who do not want to interact with the system 100.

FIG. 3 is a diagram of the multiple interactive advertising systems 101A-101N coupled together across a communications network 142. This figure illustrates how individual interactive advertising systems 101 may pull or aggregate their collective local databases 214A together. Each interactive advertising system 101 may upload portions or their entire local database 214A to the central database 214B. The central database 214B may store all the data collected by each local database 214A as well as additional data such as online purchase data and in-store data received from merchants.

FIG. 4 is a diagram of main components for an exemplary central controller 100A for the interactive advertising system 101 illustrated in FIG. 2. The exemplary operating environment for the central controller 100A includes a general-purpose computing device in the form of a conventional computer.

Generally, the computer forming the central controller 100A includes a central processing unit 121, a system memory 122, and a system bus 123 that couples various system components including the system memory 122 to the processing unit 121.

The system bus 123 may be any of several types of bus structures including a memory bus or memory controller, a peripheral bus, and a local bus using any of a variety of bus architectures. The system memory includes a read-only memory (“ROM”) 124 and a random access memory (“RAM”) 125. A basic input/output system (“BIOS”) 126, containing the basic routines that help to transfer information between elements within the computer, such as during start-up, is stored in ROM 124.

The computer 100A may include a hard disk drive 127A for reading from and writing to a hard disk, not shown, a USB port 128 for reading from or writing to a removable USB drive 129, and an optical disk drive 130 for reading from or writing to a removable optical disk 131 such as a CD-ROM, a DVD, or other optical media. Hard disk drive 127A, USB drive 129, and optical disk drive 130 are connected to the system bus 123 by a hard disk drive interface 132, a USB drive interface 133, and an optical disk drive interface 134, respectively.

Although the exemplary environment described herein employs hard disk 127A, removable USB drive 129, and removable optical disk 131, it should be appreciated by one of ordinary skill in the art that other types of computer readable media which can store data that is accessible by a computer, such as remote storage, magnetic cassettes, flash memory cards, digital video disks, Bernoulli cartridges, RAMs, ROMs, and the like, may also be used in the exemplary operating environment without departing from the scope of the system 101. Such uses of other forms of computer readable media besides the hardware illustrated may be used in Internet connected devices such as in the portable computing device 100C of FIG. 2.

The drives and their associated computer readable media illustrated in FIG. 4 provide nonvolatile storage of computer-executable instructions, data structures, program modules, and other data for computer or client device 100A. A number of program modules may be stored on hard disk 127, USB drive 129, optical disk 131, ROM 124, or RAM 125, including, but not limited to, an operating system 135, the biometric recognition module 208, the product/service recommendation module 204, and the voice recognition module 206. Program modules include routines, sub-routines, programs, objects, components, data structures, etc., which perform particular tasks or implement particular abstract data types.

A user may enter commands and information into the computer through input devices, such as a keyboard 140 and a pointing device 142. Pointing devices may include a mouse, a trackball, and an electronic pen that can be used in conjunction with an electronic tablet. Other input devices (not shown) may include a joystick, game pad, satellite dish, scanner, or the like. These and other input devices are often connected to processing unit 121 through a serial port interface 146 that is coupled to the system bus 123, but may be connected by other interfaces, such as a parallel port, game port, a universal serial bus (USB), or the like.

The display 147 may also be connected to system bus 123 via an interface, such as a video adapter 148. As noted above, the display 147 can comprise any type of display devices such as a liquid crystal display (LCD), a plasma display, an organic light-emitting diode (OLED) display, a cathode ray tube (CRT) display, a projector, and projection screen.

The camera 175 may also be connected to system bus 123 via an interface, such as an adapter 170. The camera 175 may comprise a video camera. The camera 175 can be a CCD (charge-coupled device) camera or a CMOS (complementary metal-oxide-semiconductor) camera. In addition to the monitor 147 and camera 175, the client device 100A, comprising a computer, may include other peripheral output devices (not shown), such as a printer.

The computer may also include a microphone 111 that is coupled to the system bus 123 via an audio processor 113 as understood by one of ordinary skill in the art. A microphone 111 may be used in combination with the voice recognition module 206 in order to process audible commands received from a consumer 10.

The computer forming the central controller 100A may operate in a networked environment using logical connections to one or more remote computers, such as a web server. A remote computer 100B may be another personal computer, a server, a mobile phone, a router, a networked PC, a peer device, or other common network node. While the web server or a remote computer 100B typically includes many or all of the elements described above relative to central controller 100A, only a memory storage device 127B has been illustrated in this FIG. 4. The logical connections depicted in FIG. 4 include a local area network (LAN) 142 and a wide area network (WAN) 142B. Such networking environments are commonplace in offices, enterprise-wide computer networks, intranets, and the Internet.

When used in a LAN networking environment, the computer forming the central controller 100A is often connected to the local area network 142A through a network interface or adapter 153. When used in a WAN networking environment, the computer typically includes a modem 154 or other means for establishing communications over WAN 142B, such as the Internet. Modem 154, which may be internal or external, is connected to system bus 123 via serial port interface 146. In a networked environment, program modules depicted relative to the server 100B, or portions thereof, may be stored in the remote memory storage device 127A. It will be appreciated that the network connections shown are exemplary and other means of establishing a communications link between the computers may be used.

Moreover, those skilled in the art will appreciate that the system 101 may be implemented in other computer system configurations, including hand-held devices, multiprocessor systems, microprocessor based or programmable consumer electronics, network personal computers, minicomputers, mainframe computers, and the like. The system 101 may also be practiced in distributed computing environments, where tasks are performed by remote processing devices that are linked through a communications network. In a distributed computing environment, program modules may be located in both local and remote memory storage devices.

FIG. 5 is a table 500 listing a plurality of rules that may be part of the rules engines 233 illustrated in FIG. 2. Table 500 has a plurality of columns that may be assigned for tracking demographic features such as, but not limited to, sex 510, age range 515, and ethnicity 520. The first column 505 may track a condition of whether the biometric recognition module 208 recognizes any features of a consumer 10 who has walked within the view of the camera 175 of the system 101. One of ordinary skill in the art understands that facial recognition modules may be able to determine with a relative degree of certainty the sex, age range, and ethnicity of a consumer 10 based on the features of the consumer's face. If a consumer 10 hides his or her face or does not allow a camera 175 to view his or her face completely, then the facial recognition module may not be able to determine certain features.

The first rule (RULE #1) outlines such a scenario in which there are no features of a consumer 10 recognized by the camera 175 or the biometric recognition module 208. In such a situation, the first rule may comprise directing the consumer 10 to a generic product and/or service which may be appealing across a broad range of demographics that may include the consumer 10.

The second rule (RULE #2) of the second row of table 500 outlines a scenario in which some features are recognized by the biometric recognition module 208. The second rule may require several conditions which may be required before it is applied. For example, the second rule (RULE #2) may require that the sex of the consumer 10 is male, has an age range between about 10 years to about 15 years, that his ethnicity is Hispanic, and that individualized preferences are not known for this consumer 10 so that inferred/categorical preferences may be used instead. The other rules listed in table 500 may be followed similarly by the rules engine 233.

One interesting aspect of table 500 is that preferences 525, 530 for a particular consumer 10 may also be tracked. The rules may be applied in combination with the known preferences of the consumer 10 so that unique and personalized offers are presented to each consumer 10 based on each consumer's likes and dislikes in combination with demographic data listed in the rule. The system 101 may keep track of each consumer's preferences as they answer questions about likes and dislikes while they are interacting with the display 147. Some of the consumer preferences may be stored in this table 500.

Further, the system 101 may also track popular purchases and popular views of products and/or services based on demographics recognized for each consumer 10. The system 101 may make decisions regarding which products and/or services to project onto display 147 based on its assessment of its broad range of data stored in table 500 as well as in the local and central databases 214A, 214B.

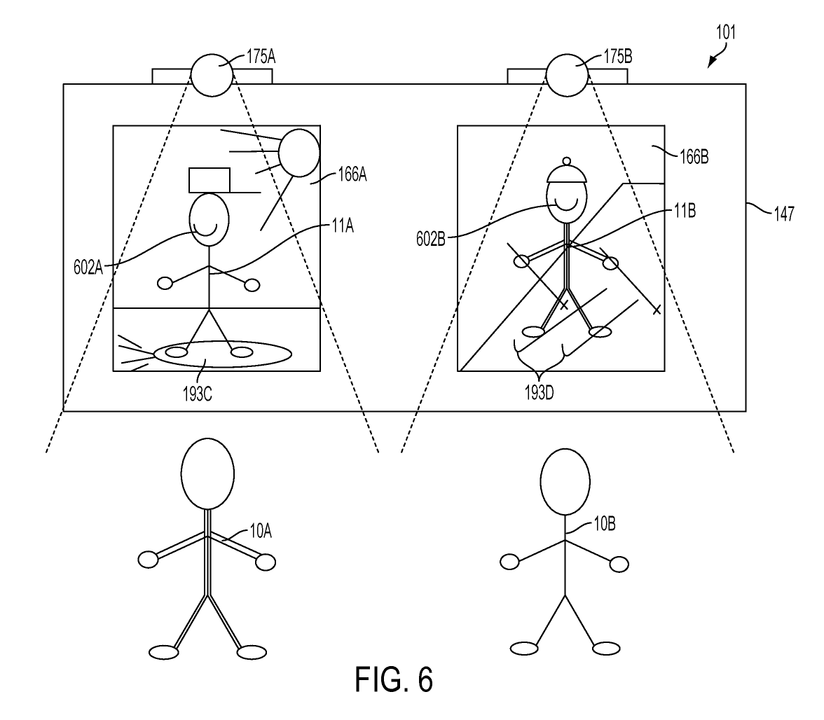

FIG. 6 is a diagram of an interactive advertising system 101 that has augmented computer-generated scenes 166 to include images 11A, 11B of two consumers 10A, 10B. In this exemplary embodiment illustrated in FIG. 6, the interactive advertising system 101 has also augmented or changed the body image for each consumer 10A, 10B. Specifically, for the first consumer 10A, the system 101 has reduced a size or “thickness” of the image 11A relative to the “real” size of the first consumer 10A. Similarly, the system 101 has increased a size or “thickness” of the image 11B relative to the “real” size of the second consumer 10B. In both computer-generated scenes 166A, 166B, the system 101 has further augmented each image 11 of each consumer 10 to include a smile in their facial expression to indicate that they are enjoying the product 193 being displayed with the system 101. These augmentations are mere examples of what the system 101 may “enhance” for the body image and facial expressions of a consumer 10. The system 101 may also display options for changing the body image and/or facial expressions of the consumer 10 that may be selected by the consumer 10.

In the exemplary embodiment of FIG. 6, a surfboard product 193C is shown in the computer-generated scene 166A. The image 11A of the first consumer 10A is shown to be enjoying the surf board product 193C on a sunny day at the beach and in the ocean. Meanwhile, ski products 193D are shown in the computer-generated scene 166B. The image 11B of the second consumer 10B is shown to be enjoying the ski products 193D on a wintry day at a mountain slope.

The system 101 is not limited to the exemplary computer-generated scenes 166 illustrated in the figures of this specification, as understood by one of ordinary skill the art. Any number of different types of scenery and images may be produced by the system 101 and shown to a consumer 10. The system 101 may display various options that may be selectable by the consumer 10 in order to change products 193, the computer-generated scene 166, as well as the body image and facial expressions of the images 11 of the consumer being projected on the display 147 in the computer-generated scenes 166.

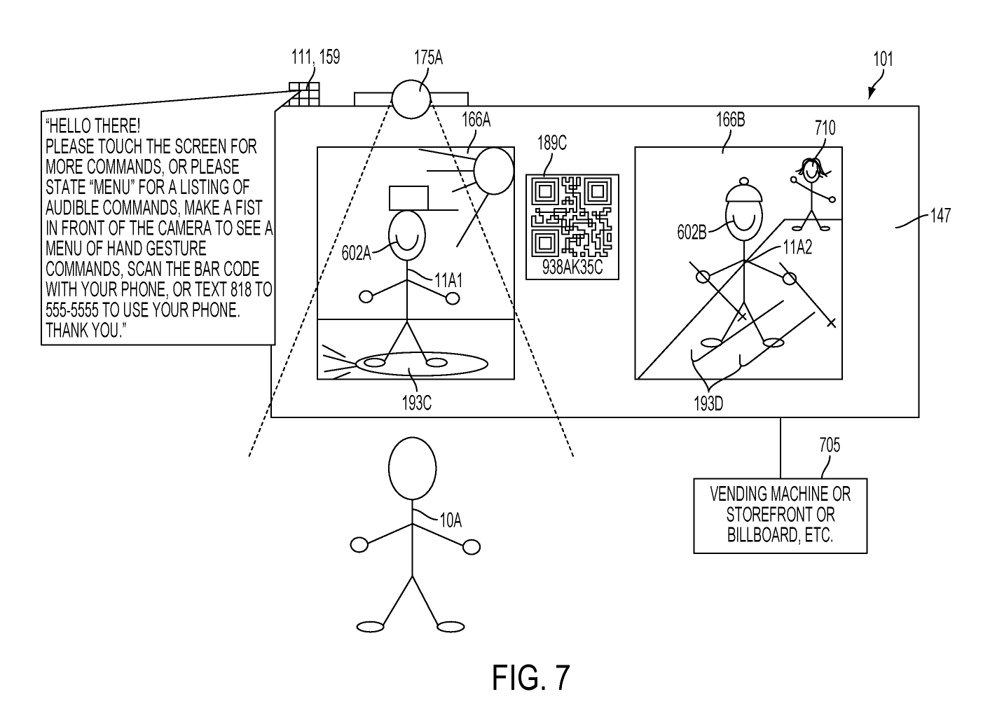

FIG. 7 is a diagram of an interactive advertising system 100 that is part of a vending machine, storefront, or billboard that are collectively designated as 705 in FIG. 7. According to this exemplary embodiment, a single camera 175 may be provided for this interactive advertising system 101. Meanwhile, two images 11A1, 11A2 of the single consumer 10A have been generated by the system 101. Similar to FIG. 6, the first computer-generated 166A scene comprises the image 11A1 of the consumer 10A enjoying a surfboard product 193C at the beach. The second computer-generated scene 166B comprises the image 11A2 of the consumer 10 enjoying ski products 193B on a ski slope.

The second computer-generated scene 166B further comprises a virtual person 710 interacting with the image 11A2 while the consumer 10 is enjoying the ski products 193B. The virtual person 710 may comprise an image of a celebrity (i.e. movie star, sports athlete, music star, stage star, etc.), an animal, a fictional character, or other animate or inanimate object based on the preferences indicated by the consumer 10. Alternatively, the system 101 may select the virtual person based on the demographics of the consumer 10 that are detected by the system 101. The system 101 may also provide options that may be selected by the consumer 10 in order to change which virtual persons 710 are generated by the system 101.

As illustrated in FIG. 7, the interactive advertising system 101 may also comprise a speaker 159 and a microphone 111 subsystem for communicating with the consumer 10A. For example, the system 101 may use the speaker 159 to instruct how the consumer 10A may interact with the system 101. The system 101 may describe to the consumer 10A how he or she can issue commands to the system 101.

In the exemplary embodiment illustrated in FIG. 7, the speaker 159 is illustrated to show that it states to the consumer 10A that he or she may touch the screen 147 for further commands or the consumer 10A may speak into the microphone 111 to issue his or her commands to the system 101. Further, the system 101 may communicate that the consumer 10A may use hand gesture commands to further interact with the system 101.

Alternatively, the system 101 may also provide options for the consumer 10A to interact with the system 101 by using a portable computing device 100B, such as a mobile phone. If the consumer 10A elects to use a portable computing device 100B, then he or she may scan in the machine-readable code 189C. Alternatively, he or she may input or enter a code into the portable computing device 100B that is relayed to the system 101 or over the communication network 142, such as texting a code to a specific phone number provided by the system 101.

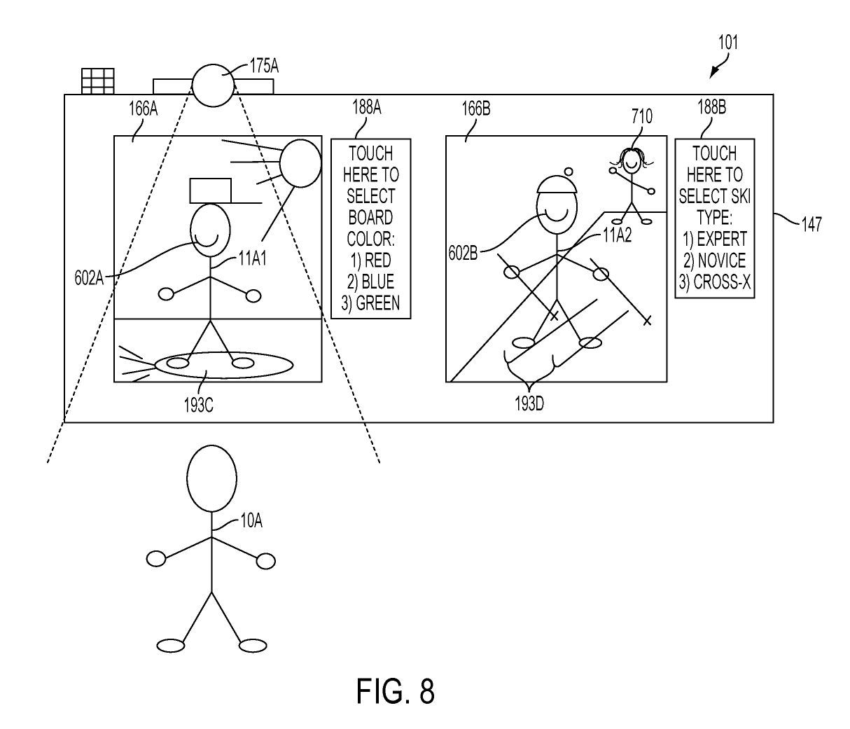

FIG. 8 is a diagram of an interactive advertising system 101 that has augmented a plurality of computer-generated scenes 166A, 166B to include an image of a single consumer 10A. The interactive advertising system 101 has displayed menu options 188A, 188B that may be selected by the consumer 10A for changing features of the products 193 that are being advertised with the system 101. As noted previously, the system 101 may provide additional selectable menu options 188 for changing any aspect of the computer-generated scene 166. That is, the consumer 10A may be able to change the products and/or services 193, scenery of the computer generated scene 166, the virtual persons 710 that are part of the computer-generated scene 166, as well as the body image and facial expression of the images 11A1, 11A2 being projected into the computer-generated scene 166.

In the exemplary embodiment illustrated in FIG. 8, the consumer 10A has elected to use the touchscreen of the display 147 in order to interact with the system 101. However, as noted above, the consumer 10A may switch at any time during his or her interaction to the other types of user interfaces that are supported by the system 101 in order to change the display 147 of the system 101. For example, after the consumer 10A has decided to use the touchscreen commands for the display 147, the consumer 10A may elect to further interact with the system 101 by using voice commands, using his or her portable computing device 100B, using hand gesture commands, and any combination thereof as understood by one of ordinary skill in the art. All of the options that are selected by the consumer 10B may be tracked by the system 101 and stored as preference/profile data associated with the consumer 10A in the local database 214A as well as the central database 214B.

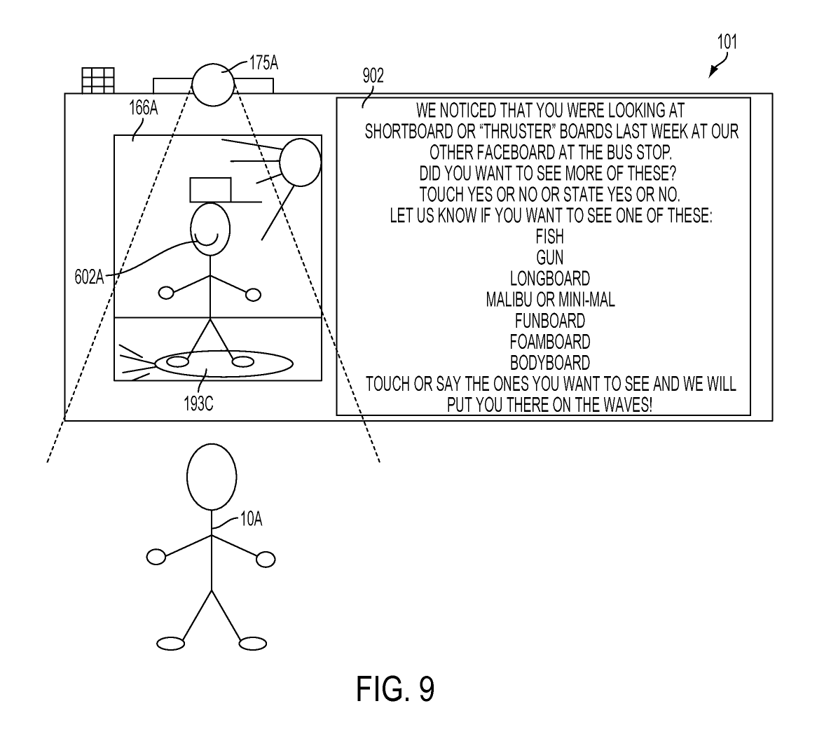

FIG. 9 is a diagram of an interactive advertising system 101 that displays products or services 193 (or both) that are based on preferences of a consumer that are stored in the local database 214A or central database 214B. In the exemplary embodiment illustrated in FIG. 9, the system 101 may display a text-based message 902 on the display 147 that provides the consumer 10A with different options for products 193 that are based on preference data/profile data stored in the local database 214A or the central database 214B. As noted previously, the interactive advertising system 101 may display the text-based message 902 while also generating synthetic speech with the speaker 159 at the same time that the text-based message 902 is being displayed. Alternatively, the system 101 may only provide synthetic speech with the speaker 159 and not display the text-based message 902 at all. Various combinations of communicating messages about the display 147 may be employed by the system 101 and may be dictated by preference data/profile data for a particular consumer 10.

In the specific example of FIG. 9, the system 101 conveys the message 902 that it has noticed that the consumer 10A has been looking at two different types of surfboard products 193 at an earlier time and with a different interactive advertising system 101 (the one at the bus stop). The system 101 asks if the consumer 10A wants to see more products 193 in the same category or if the consumer 10A wants to see other products in different sub-categories. The consumer 10A may express his or her desired options by following one of the suggested user interface methods (i.e. using voice commands, using the touchscreen, using his or her portable computing device 100B, etc.).

FIG. 10 is a diagram of an interactive advertising system 101 that displays a plurality of options for completing a purchase transaction or for preserving a potential purchase transaction. FIG. 10 illustrates a text-based message 1002 that was generated in response to the consumer 10A of FIG. 9 selecting the answer of “No” to the question of whether the consumer 10A desires to see more surfboard products 193. The text-based message 1002 asks if the consumer 10A wants to purchase the displayed surfboard product 193C now or if the consumer 10A desires to save this particular product 193C to his or her profile stored in the local database 214A or the central database 214B (or both).

The text-based message 1002 of FIG. 10 also asks if the consumer 10A desires to issue a command so that a clerk in the store of a merchant will hold the product 193C in the store so that the consumer 10A may examine or try on the actual product 193C before it is purchased. As noted previously, the system 101 may also produce synthetic speech that reads this text-based message 1002. Alternatively, the system 101 may forgo displaying the text-based message 1002 and only generate synthetic speech with the speaker 159.

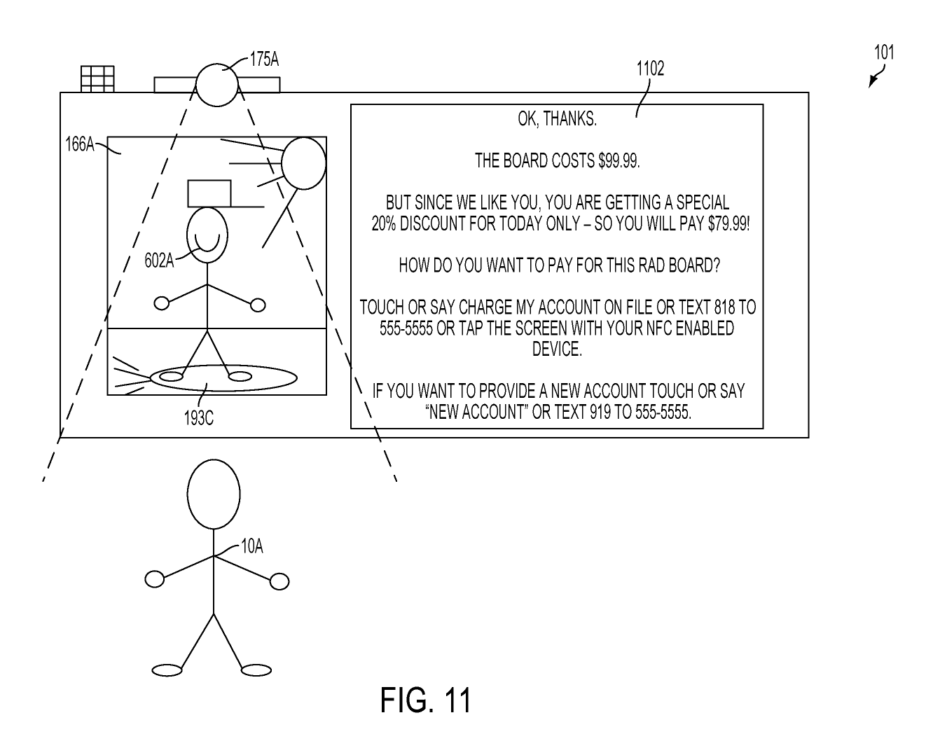

FIG. 11 is a diagram of an interactive advertising system 101 that displays options for completing a purchase transaction. According to this exemplary embodiment of FIG. 11, the system 101 has generated a text-based message 1102 in response to the consumer 10A selecting the “purchase board now” option displayed in FIG. 10. The text-based message 1102 further comprises a personalized and unique offer for the consumer 10A. According to the exemplary embodiment illustrated, this personalized and unique offer is an additional discount taken off the final purchase price of the product 193C. This additional discount of 20% offered to the consumer 10A may have been generated based on loyalty data that is stored in the local database 214A or central database 214B. The additional discount may also be part of a rule executed by the rules engine 233.

The text-based message 1102 also lists payment options of how the consumer 10A may purchase the product 193C. One option includes the ability of the consumer 108 to charge a payment account that is on file and which may be stored in the local database 214A or the central database 214B (or both). Another option includes the consumer 10A having the ability to use his or her portable computing device 100B to complete the purchase of the product 193C. A further option includes the ability for the consumer 10A to open up a new payment account using the display 147 of the system 101.

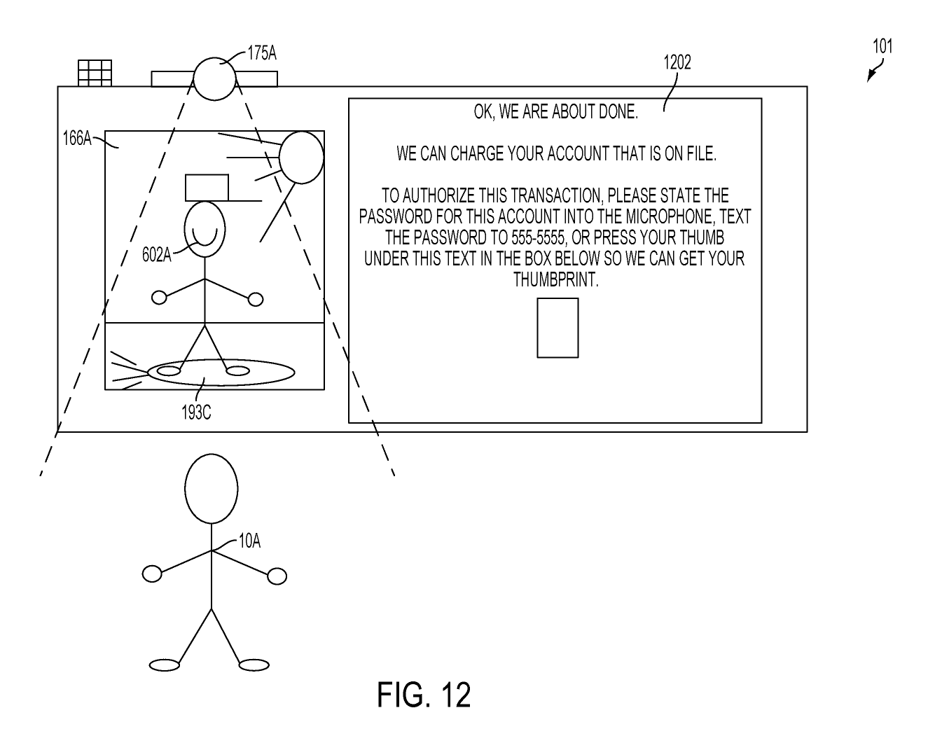

FIG. 12 is a diagram of an interactive advertising system 101 that displays instructions on how to complete a purchase transaction using the interactive advertising system 101. According to this exemplary embodiment, a text-based message 1202 is projected on the display 147 and is generated in response to the consumer 10A selecting the “charge my account on file” option displayed in FIG. 11. The text-based message 1202 further comprises options for the consumer 10A to select in order to authorize the payment for the purchase of the product 193C. Various authorization options may be provided with the system 101 as understood by one of ordinary skill the art. In public viewing environments (i.e. displays 147 at storefronts on a street), the system 101 may offer a restricted set of authorization options so that security is not compromised by the display 147 which may be viewable by passersby or by the speaker 159 which may be heard by passersby.

In the exemplary embodiment illustrated in FIG. 12, the consumer 10A is provided with the options of stating a password into the microphone 111 for voice authentication of the account on file with the system 101. Another option provided is allowing the consumer 10A to use their portable computing device 100B to transmit a password associated with the account on file with the system 101. A further option provided is allowing the consumer 10A to use a biometric, such as a fingerprint, to authenticate the transaction with the account on file with the system 101. Various other authentication methods are within the scope of this disclosure as understood by one of ordinary skill the art. As one example, the consumer 10A may sign in the “air” his or her signature with a finger and the system 101 can track the finger and authenticate the signature based on the finger motion.

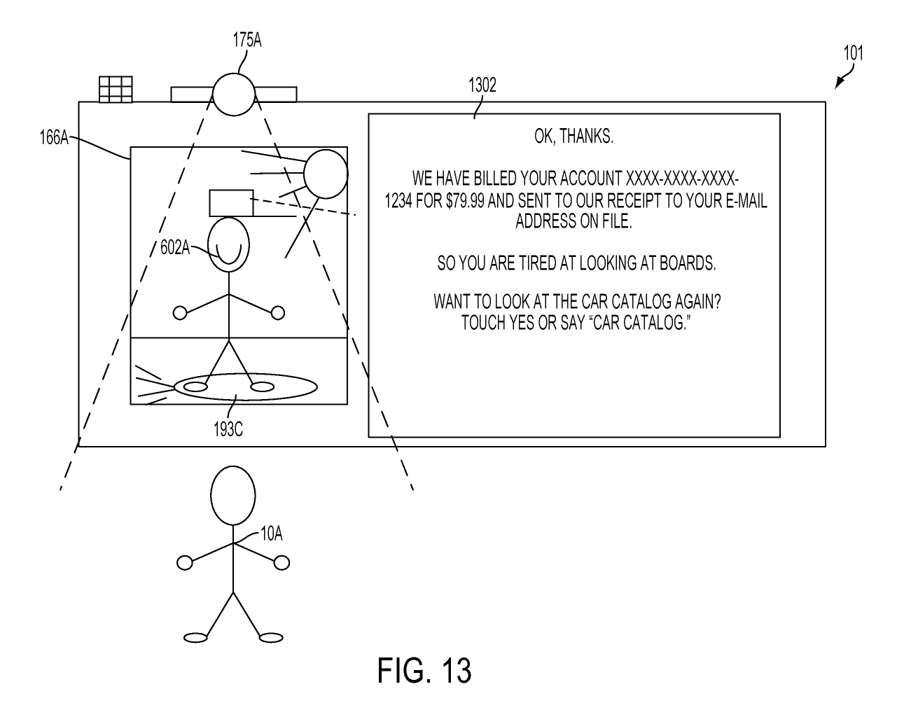

FIG. 13 is a diagram illustrating an interactive advertising system 101 that displays a purchase confirmation screen and options for changing the products and services currently being advertised on the interactive advertising system 101. In the exemplary embodiment illustrated in FIG. 13, a text-based message 1302 was generated in response to the consumer 10A authenticating a transaction for purchasing the product 193C as illustrated in FIG. 12. The text-based message 1302 confirms that payment has been received by the system 101 based on the payment account selected in FIG. 12.

The text-based message 1302 further provides options to the consumer 10A for searching additional products/services 193 using the interactive advertising system 101. The system 101 may suggest other products/services 193 for the consumer 10A to look at that are based on preference data and/or prior selections that were made by the consumer 10A or by other consumers who made the same or similar purchases. The preference data and/or prior selections may be stored in the local database 214A or central database 214B (or both). In this way, the interactive advertising system 101 becomes an on-line catalog for the consumer 10A so that he or she may look at products and/or services 193 from various different types of merchants that are subscribers of the interactive advertising system 101.

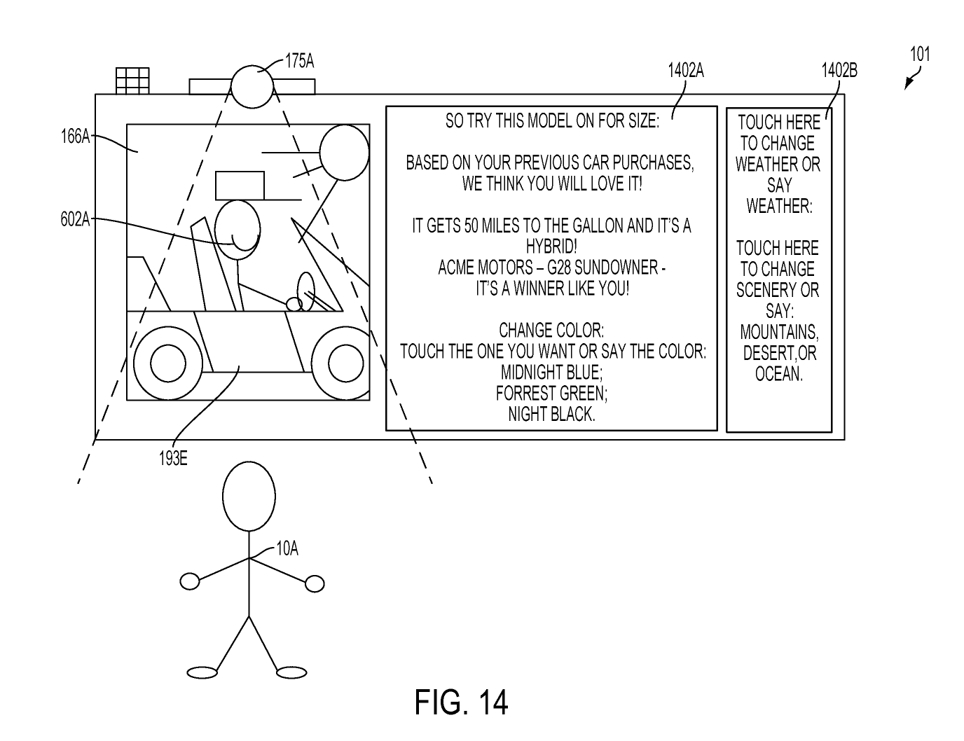

FIG. 14 is a diagram illustrating an interactive advertising system 101 that displays a new set of product categories that are specific to a consumer 10A based on preferences and prior purchase data available to the interactive advertising system 101. In this exemplary embodiment, the text-based message 1402 may be generated in response to the consumer 10A selecting the “car catalog” option offered in the display 147 illustrated in FIG. 13.

The text-based message 1402 may comprise information about a car product 193E that was selected by the system 101 using the rules engine 233 and/or preference data/profile data stored in either the local database 214A or central database 214B (or both). The text-based message 1402 may further display options for changing colors of the displayed car product 193E as well as options for changing the scene 166 such as changing the weather, driving environment, etc.

In the exemplary embodiment illustrated in FIG. 14, the image 11A of the consumer 10A is shown to be driving a new car product 193E. The image 11A of the consumer 10A is further augmented to include a facial expression 602A comprising a smile and associated with satisfaction of driving the car product 193E. As another exemplary embodiment, the image 11A of the consumer 10A may evolve into a “driving” game in which the consumer may control movements of the image 11A by the system tracking various movements of the consumer 10A. For example, the consumer may pretend he or she is holding a steering wheel of the car product 193E and the system 101 may track this movement of the consumer's hands and translate the movements as commands for steering the car product 193E.

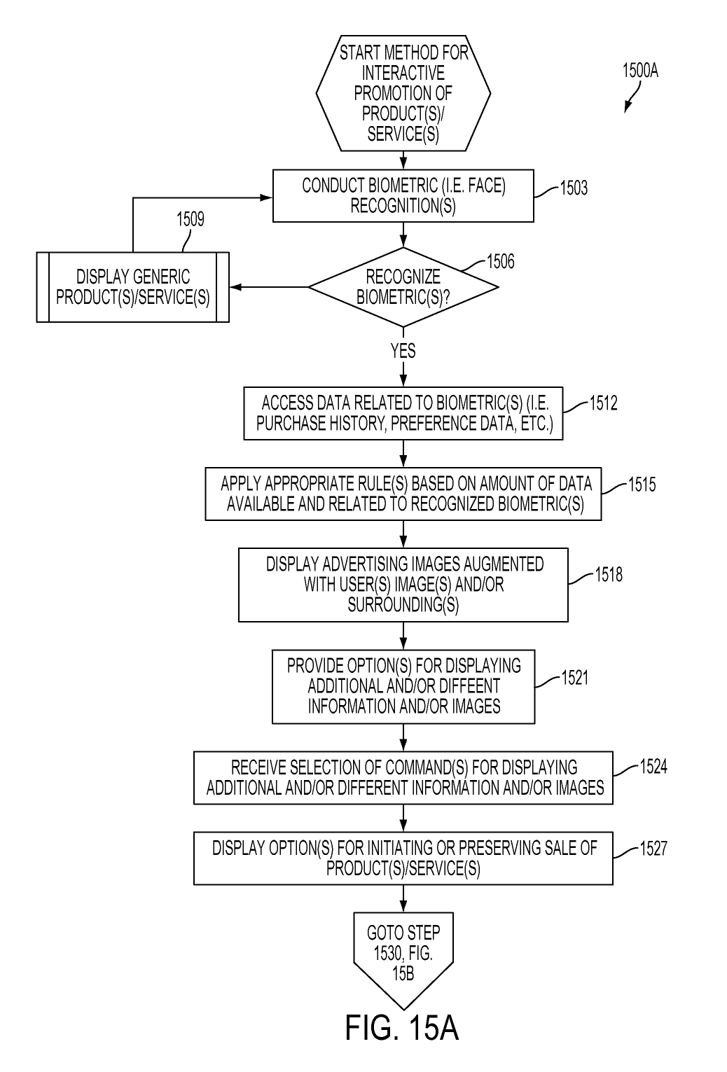

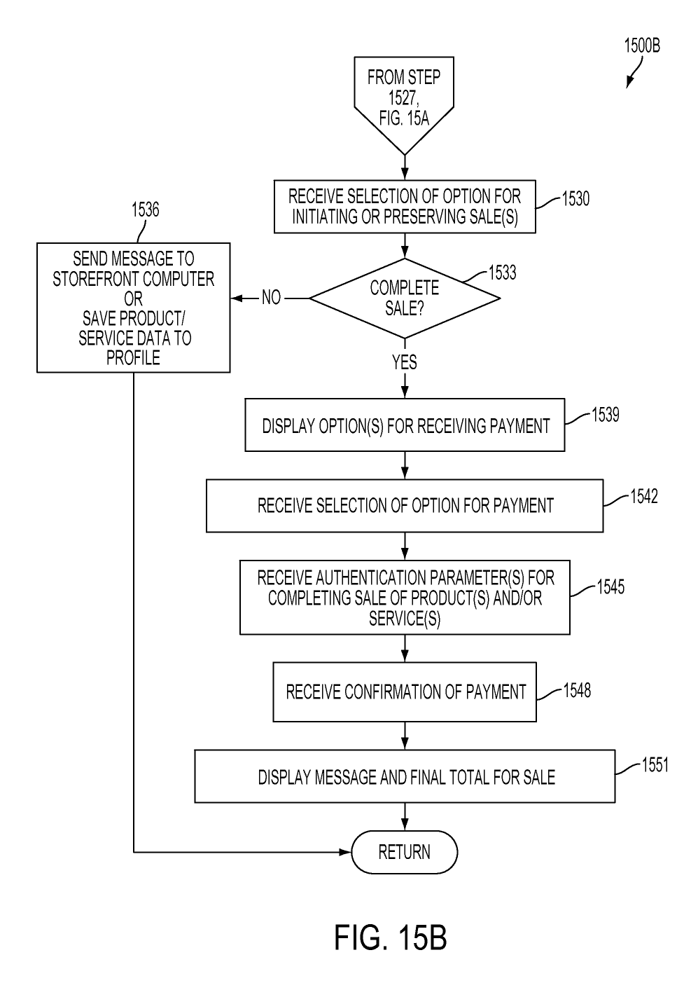

FIGS. 15A-15B are flowcharts illustrating a method 1500 for interactively promoting products and/or services 193. The first step of method 1500 is block 1503 as illustrated in FIG. 15A. In block 1503, the system 101 and particularly the central controller 100 may conduct one or more biometric scans that may include scanning images for faces of consumers 10 captured with a camera 175.

Next, in decision block 1506, the system 101 determines if any of the biometrics being scan have been recognized. If the inquiry to decision block 1506 is negative, then the “No” branch is followed to subroutine 1509.

If the inquiry to decision block 1506 is positive, then the “YES” branch is followed to block 1512. In subroutine 1509, the system 101 may generate displays that include generic products/services 193 which may appeal to a broad range or broad class of demographics. Subroutine 1509 may include the execution of one of the rules by the rules engine 233 as illustrated in FIG. 5.

In block 1512, the system 101 and particularly the central controller 100A may access data stored in a local database 214A or a central database 214B (or both). This data may be related to the biometrics recognized in step 1506 and may include purchase history, preferences, and profile data. As noted previously, the names of consumers 10 may or may not be provided in the databases 214. Instead of using names of consumers 10, the system 101 may associate biometrics such as faces or fingerprints with certain profiles or usage history.

At this stage in block 1512, as an exemplary operation, the system 101 may only “know” that a consumer 10A is male, or is a male between the ages of about thirty to forty years. The system 101 may know that the particular face of the consumer 10A has been “viewed” by the system 101 before and for which the consumer 10A has generated browsing or purchase history or user-entered preferences. The system 101 at this stage in block 1512 may either “know” (i.e. infer) nothing about the consumer 10A, or the system may infer one or more of a consumer's sex, age, ethnicity, and identity, as well as other similar classification characteristics.

As will be described below, the system 101 may have different rules depending on whether the system 101 “knows” (1) nothing, (2) the identity of the consumer 10A, or (3) one or more of sex, age, and ethnicity, and other classification characteristics of the consumer 10A. Recommendations from the system 101 for a consumer 10A may vary depending on the season of the year, the time of the day, the temperature outside, the weather/i.e.—whether it is raining, etc. For example, the system 101 may have a rule as follows: During the summer season, show consumer 10A in bathing suits if the temperature is 100 degrees Fahrenheit or above, shorts if the temperature is between approximately 90-99 degrees Fahrenheit, and jeans if the temperature is below approximately 90 degrees Fahrenheit. Similarly, another rule may include—during the winter season, show consumer 10A in ski outfits and skis, and display him on a ski run.

Next, in block 1515, the system 101 may apply appropriate rules such as those illustrated in FIG. 5 based on the amount of data available and which is related to one of the recognized biometrics. In this block 1515, the rules engine 233 may be executing one or more rules that are described above in connection with FIG. 5.

In block 1518, after the rules engine 233 has executed its one or more rules, the system 101 may display advertising images that are augmented with user images 11 and/or different surroundings as illustrated in FIGS. 6-14. Next, in block 1521, the system 101 may provide one or more options for displaying additional and/or different information and/or images on the display 147. These options may generally comprise menus 188 that may either be text-based or audio based (or both) as understood by one of ordinary skill the art. As noted previously, the system 101 allows the consumer 10 to control all aspects of the display 147 such as providing the ability to change products/services 193, scenery, virtual persons 710 present within the computer-generated scenes 166, as well as the ability to augment the image 11 of the consumer 10.

In block 1524, the system 101A receives a selection of one or more commands for displaying additional and/or different information and/or images on the display 147. In block 1527, the system 101 may display options in the form of menus 188 for initiating or preserving a sale of one or more products/services 193. For example, FIG. 10 illustrates exemplary options that allow a consumer 10 to initiate a sale or preserve options for a sale.

The method 1500A then continues from FIG. 15A to block 1530 of FIG. 15B. FIG. 15B illustrates a continuation flow diagram relative to the method 1500A illustrated in FIG. 15A.

Block 1530 is the first step illustrated in FIG. 15B. In block 1530, the system 101 may receive a selection of the one or more options for initiating or preserving a sale of products/services 193. In decision block 1533, the system 101 determines if the consumer 10 has decided to complete a sale for the purchase of a product/service 193. Decision block 1533 generally corresponds to FIG. 10 is above.

If the inquiry to decision block 1533 is negative, then the “NO” branch is followed to block 1536. If the inquiry to decision block 1533 is positive, then the “YES” branch is followed to block 1539.

In block 1536, the system 101 may send a message to a store front computer 100B such as illustrated in FIG. 2. This message may comprise a request for pulling a product 193 for viewing by the consumer 10 prior to completing a purchase. Alternatively, this message may comprise a request for a record describing the product/service 193 to be saved in a profile in the database 214 associated with the consumer 10.

In block 1539, the system 101 may display a plurality of options for receiving payment from the consumer 10. This block 1539 may generally correspond with FIG. 11 in which a plurality of payment options is displayed in the text message 1102. Next, in block 1542, the system 101 may receive a selection of the options for payment. In block 1545, the system 101 may receive one or more authentication parameters for completing a sale of the product/service 193. Block 1542 may generally correspond with the authentication display which is part of the text-based message 1202 of FIG. 12.

Next, in block 1548, the system 101 may communicate with the payment systems 173 that correspond with the payment options selected in blocks 1539 and 1542. The system 101 may receive the confirmation of payment from the payment systems 173 if the payments are approved. And in block 1551, the system 101 may display a message and final total that was charged against the authorized payment account. This block 1551 may generally correspond with FIG. 13 in which a text-based message 1302 is displayed and which comprises a confirmation indicating which payment account was charged for the purchase of the product/service 193. The method 1500 may then return back to the first block 1503 of FIG. 15A.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the disclosure. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments for the interactive advertising system 101 will become apparent to one of ordinary skill in the art to which this disclosure pertains. For example, the interactive advertising system 101 may comprise a laptop computer or personal computer for consumers 10 who shop at home and over the Internet. The display 147 may comprise a computer screen for either a laptop or desktop computer 100. This way, the system 101 may promote sales of products online without a consumer 10 ever leaving his or her home.

The interactive advertising system 101 may allow the consumer 10 to create his or her own virtual world of advertising. For example, the consumer 10 may choose to select a movie theme, theatrical theme, or video game in relation to the product/services 193 that are being displayed on the display device 147. The consumer 10 may choose to become a character from a popular movie or video game in order to interact with the products/services 193 that are being displayed.

Further, the system 101 may cause the virtual persons 710 to positively interact with the image 11 of the consumer 10. For example, for a male consumer 10, the system 101 may project a celebrity female as the virtual person 710 that positively interacts with the image 11 of the consumer 10. This positive interaction may comprise audio, text, and/or video so that the image 11 of the consumer 10 appears to have a “real world” interaction with the virtual person 710 projected on the display device 147.

Therefore, although selected aspects have been illustrated and described in detail, it will be understood that various substitutions and alterations may be made therein without departing from the spirit and scope of the present invention, as defined by the following claims.

What is claimed is:

1. A method for interactively promoting the sale of a product or service, the method comprising:
capturing an image of a consumer;
conducting a biometric scan of the image;
recognizing at least one biometric from the biometric scan;
determining if the at least one biometric is associated with at least one of browsing history, purchase history, and preference data, wherein the browsing history, the purchase history, and the preference data are associated with the consumer; and
if the at least one biometric is associated with the at least one of browsing history, purchase history, and preference data, displaying advertising images on a display device, the advertising images comprising at least one image of the consumer augmented with a product or service.

2. The method of claim 1, wherein the at least one biometric comprises at least one of a facial feature, a voice print feature, a fingerprint feature, a handshape feature, a retina feature, and a DNA feature.

3. The method of claim 1, further comprising:
receiving commands for changing the display that comprise at least one of touchscreen commands, voice commands, hand gesture commands, and commands received from a portable computing device.

4. The method of claim 1, further comprising:
conveying options for at least one of initiating a sale and preserving a sale of the product or service.

5. The method of claim 1, further comprising:
changing at least one of a body image and facial expression of the consumer as displayed in the advertising images.

6. The method of claim 1, further comprising:
displaying a virtual person on the display device interacting with the advertising images of the consumer.

7. The method of claim 6, wherein the virtual person comprises a celebrity.

8. The method of claim 6, wherein the virtual person comprises a fictional character, a fictional being, or a fictional item.

9. The method of claim 4, wherein the step of conveying options for at least one of initiating a sale and preserving a sale of the product or service further comprises at least one of:
conveying an option for purchasing the product or service;
conveying an option for saving a record of the product or service to a profile; or
conveying an option for sending a message to a merchant to make the product or service available to the consumer prior to purchase.

10. The method of claim 1, further comprising:
conveying options for changing one or more features of the product or service being displayed on the display device.

11. The method of claim 1, further comprising:
conveying options for changing one or more elements of a computer-generated scene comprising the product or service and an image of the consumer.

12. The method of claim 1, wherein the product or service displayed in the advertising images is selected based on at least the browsing history, the purchase history, or the preference data.

13. A computer system for interactively promoting the sale of a product or service, the system comprising:
a processor operable for:
capturing an image of a consumer;
conducting a biometric scan of the image;
recognizing at least one biometric from the biometric scan;
determining if the at least one biometric is associated with at least one of browsing history, purchase history, and preference data, wherein the browsing history, the purchase history, and the preference data are associated with the consumer; and
if the at least one biometric is associated with the at least one of browsing history, purchase history, and preference data, displaying advertising images on a display device, the advertising images comprising at least one image of the consumer augmented with a product or service.

14. The system of claim 13, wherein the at least one biometric comprises at least one of a facial feature, a voice print feature, a fingerprint feature, a handshape feature, a retina feature, and a DNA feature.

15. The system of claim 13, wherein the processor is further operable for:
receiving commands for changing the display that comprise at least one of touchscreen commands, voice commands, hand gesture commands, and commands received from a portable computing device.

16. The system of claim 13, wherein the processor further operable for:
conveying options for at least one of initiating a sale and preserving a sale of the product or service.

17. The system of claim 13, wherein the processor is further operable for:
changing at least one of a body image and facial expression of the consumer as displayed in the advertising images.

18. The system of claim 13, wherein the processor is further operable for:
displaying a virtual person on the display device interacting with the advertising images of the consumer.

19. The system of claim 18, wherein the virtual person comprises a celebrity.

20. The system of claim 18, wherein the virtual person comprises a fictional character, a fictional being, or a fictional item.

21. The system of claim 16, wherein the processor being further operable for conveying options for at least one of initiating a sale and preserving a sale of the product or service further comprises at least one of the processor being operable for:
conveying an option for purchasing the product or service;
conveying an option for saving a record of the product or service to a profile; or
conveying an option for sending a message to a merchant to make the product or service available to the consumer prior to purchase.

22. The system of claim 13, wherein the processor is further operable for:
conveying options for changing one or more features of the product or service being displayed on the display device.

23. The system of claim 13, wherein the processor is further operable for:
conveying options for changing one or more elements of a computer-generated scene comprising the product or service and an image of the consumer.

24. The system of claim 13, wherein the product or service displayed in the advertising images is selected based on at least the browsing history, the purchase history, or the preference data.

25. A computer system for interactively promoting the sale of a product or service, the system comprising:
means for capturing an image of a consumer;
means for conducting a biometric scan of the image;
means for recognizing at least one biometric from the biometric scan;
means for determining if the at least one biometric is associated with at least one of browsing history, purchase history, and preference data, wherein the browsing history, the purchase history, and the preference data are associated with the consumer; and
means for displaying advertising images on a display device, the advertising images comprising at least one image of the consumer augmented with a product or service if the at least one biometric is associated with the at least one of browsing history, purchase history, and preference data.

26. The system of claim 25, wherein the at least one biometric comprises at least one of a facial feature, a voice print feature, a fingerprint feature, a handshape feature, a retina feature, and a DNA feature.

27. The system of claim 25, further comprising:
means for receiving commands for changing the display that comprise at least one of touchscreen commands, voice commands, hand gesture commands, and commands received from a portable computing device.

28. The system of claim 25, further comprising:
means for conveying options for at least one of initiating a sale and preserving a sale of the product or service.

29. The system of claim 25, further comprising:
means for changing at least one of a body image and facial expression of the consumer as displayed in the advertising images.

30. The system of claim 25, further comprising:
means for displaying a virtual person on the display device interacting with the advertising images of the consumer.

31. The system of claim 30, wherein the virtual person comprises a celebrity.

32. The system of claim 30, wherein the virtual person comprises a fictional character, a fictional being, or a fictional item.

33. The system of claim 28, wherein the means for conveying options for at least one of initiating a sale and preserving a sale of the product or service further comprises at least one of:
means for conveying an option for purchasing the product or service;
means for conveying an option for saving a record of the product or service to a profile; or
means for conveying an option for sending a message to a merchant to make the product or service available to the consumer prior to purchase.

34. The system of claim 25, further comprising:
means for conveying options for changing one or more features of the product or service being displayed on the display device.

35. The system of claim 25, further comprising:
means for conveying options for changing one or more elements of a computer-generated scene comprising the product or service and an image of the consumer.

36. The system of claim 25, wherein the product or service displayed in the advertising images is selected based on at least the browsing history, the purchase history, or the preference data.

37. A computer program product comprising a computer usable medium having a computer readable program code embodied therein, said computer readable program code adapted to be executed to implement a method for interactively promoting the sale of a product or service, said method comprising:
capturing an image of a consumer;
conducting a biometric scan of the image;
recognizing at least one biometric from the biometric scan;
determining if the at least one biometric is associated with at least one of browsing history, purchase history, and preference data, wherein the browsing history, the purchase history, and the preference data are associated with the consumer; and
if the at least one biometric is associated with the at least one of browsing history, purchase history, and preference data, displaying advertising images on a display device, the advertising images comprising at least one image of the consumer augmented with a product or service.

38. The computer program product of claim 37, wherein the at least one biometric comprises at least one of a facial feature, a voice print feature, a fingerprint feature, a handshape feature, a retina feature, and a DNA feature.

39. The computer program product of claim 37, wherein the program code implementing the method further comprises:
receiving commands for changing the display that comprise at least one of touchscreen commands, voice commands, hand gesture commands, and commands received from a portable computing device.

40. The computer program product of claim 37, wherein the program code implementing the method further comprises:
conveying options for at least one of initiating a sale and preserving a sale of the product or service.

41. The computer program product of claim 37, wherein the program code implementing the method further comprises:
changing at least one of a body image and facial expression of the consumer as displayed in the advertising images.

42. The computer program product of claim 37, wherein the program code implementing the method further comprises:
displaying a virtual person on the display device interacting with the advertising images of the consumer.

43. The computer program product of claim 42, wherein the virtual person comprises a celebrity.

44. The computer program product of claim 42, wherein the virtual person comprises a fictional character, a fictional being, or a fictional item.

45. The computer program product of claim 40, wherein the step of conveying options for at least one of initiating a sale and preserving a sale of the product or service further comprises at least one of:
conveying an option for purchasing the product or service;
conveying an option for saving a record of the product or service to a profile; or
conveying an option for sending a message to a merchant to make the product or service available to the consumer prior to purchase.

46. The computer program product of claim 37, wherein the program code implementing the method further comprises:
conveying options for changing one or more features of the product or service being displayed on the display device.

47. The computer program product of claim 37, wherein the program code implementing the method further comprises:
conveying options for changing one or more elements of a computer-generated scene comprising the product or service and an image of the consumer.

48. The computer program product of claim 37, wherein the product or service displayed in the advertising images is selected based on at least the browsing history, the purchase history, or the preference data.
